(19) United States
(12) Patent Application Publication
(10) Pub. No.: US 2026/0058846 A1
(43) Pub. Date: Feb. 26, 2026

(54) NEURAL NETWORK-BASED CHANNEL ESTIMATION WITH VARYING INPUT SIZES IN WIRELESS COMMUNICATION

(71) Applicant: Samsung Electronics Co., Ltd., Suwon-si (KR)

(72) Inventors: Tianyu Li, Quebec (CA); Yan Xin, Princeton, NJ (US); Jianzhong Zhang, Dallas, TX (US)

(21) Appl. No.: 19/183,731

(22) Filed: Apr. 18, 2025

Related U.S. Application Data
(60) Provisional application No. 63/685,619, filed on Aug. 21, 2024.
(60) Provisional application No. 63/686,363, filed on Aug. 23, 2024.

(51) Int. Cl. H04L 25/02; G06N 3/044

(52) U.S. Cl. CPC H04L 25/0254; G06N 3/044

(57) ABSTRACT

A BS includes a processor. The processor is configured to obtain a training data set for a varying size input channel estimation (CE) model, the training data having at least a first size, and train the varying size input CE model with the training data set. The BS also includes a transceiver operatively coupled to the processor. The transceiver is configured to receive, over a wireless communication channel, a sounding reference signal (SRS). The processor is further configured to provide, to the trained varying size input CE model, an input signal based on the SRS, the input signal having a size that is one of the first size or a second size different from the first size, and receive, from the trained varying size input CE model, a CE for the wireless communication channel generated by the trained varying size input CE model based on the input signal.

### CROSS-REFERENCE TO RELATED APPLICATIONS AND CLAIM OF PRIORITY

This application claims priority under 35 U.S.C. § 119 (e) to U.S. Provisional Patent Application No. 63/685,619 filed on Aug. 21, 2024, and U.S. Provisional Patent Application No. 63/686,363 filed on Aug. 23, 2024. The above-identified provisional patent applications are hereby incorporated by reference in their entirety.

### TECHNICAL FIELD

This disclosure relates generally to wireless networks. More specifically, this disclosure relates to neural network (NN)-based channel estimation (CE) with varying input sizes.

### BACKGROUND

In wireless communication, channel estimation processes are utilized to provide reliable transmission of data between transmitters and receivers. Wireless communication systems are inherently susceptible to various impairments and variations in the radio propagation environment, leading to fluctuations in the channel characteristics. Channel estimation seeks to mitigate the adverse effects of these variations by providing accurate information about the current state of the communication channel.

### SUMMARY

This disclosure provides NN-based CE with varying input sizes.

In one embodiment, a base station (BS) is provided. The BS includes a processor. The processor is configured to obtain a training data set for a varying size input channel estimation (CE) model, the training data having at least a first size, and train the varying size input CE model with the training data set. The BS also includes a transceiver operatively coupled to the processor. The transceiver is configured to receive, over a wireless communication channel, a sounding reference signal (SRS). The processor is further configured to provide, to the trained varying size input CE model, an input signal based on the SRS, the input signal having a size that is one of the first size or a second size different from the first size, and receive, from the trained varying size input CE model, a CE for the wireless communication channel generated by the trained varying size input CE model based on the input signal.

In another embodiment, a method of operating a BS is provided. The method includes obtaining a training data set for a varying size input CE model, the training data having at least a first size, and training the varying size input CE model with the training data set. The method also includes receiving, over a wireless communication channel, an SRS, and providing, to the trained varying size input CE model, an input signal based on the SRS, the input signal having a size that is one of the first size or a second size different from the first size. The method also includes receiving, from the trained varying size input CE model, a CE for the wireless communication channel generated by the trained varying size input CE model based on the input signal.

In yet another embodiment, a non-transitory computer readable medium embodying a computer program is provided. The computer program includes program code that, when executed by a processor of a device, causes the device to obtain a training data set for a varying size input CE model, the training data having at least a first size, and train the varying size input CE model with the training data set. The program code also causes the device to receive, over a wireless communication channel, an SRS, and provide, to the trained varying size input CE model, an input signal based on the SRS, the input signal having a size that is one of the first size or a second size different from the first size. The program code also causes the device to receive, from the trained varying size input CE model, a CE for the wireless communication channel generated by the trained varying size input CE model based on the input signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4A-4B illustrate examples of uplink pilot signals according to embodiments of the present disclosure;

FIG. 5 illustrates an example cyclic prefix OFDM uplink system with a channel estimation model according to embodiments of the present disclosure;

FIG. 6 illustrates an example BRNN according to embodiments of the present disclosure;

FIG. 7 illustrates an example GRU according to embodiments of the present disclosure;

FIGS. 8A-8B illustrate an example BRNN-GRU based process for CE according to embodiments of the present disclosure;

FIG. 9 illustrates an example ResNet based process for CE according to embodiments of the present disclosure;

FIG. 10 illustrates an example U-Net based process for CE according to embodiments of the present disclosure;

FIG. 11 illustrates an example process for split data testing according to embodiments of the present disclosure;

FIG. 12 illustrates an example split data training routine according to embodiments of the present disclosure;

FIGS. 13A-13B illustrate an example CNN feature powered RNN-based process for CE according to embodiments of the present disclosure;

FIG. 14 illustrates an example process for MTL based mixed SNRs training according to embodiments of the present disclosure; and

FIG. 15 illustrates an example method for NN-based CE with varying input sizes according to embodiments of the present disclosure.

### DETAILED DESCRIPTION

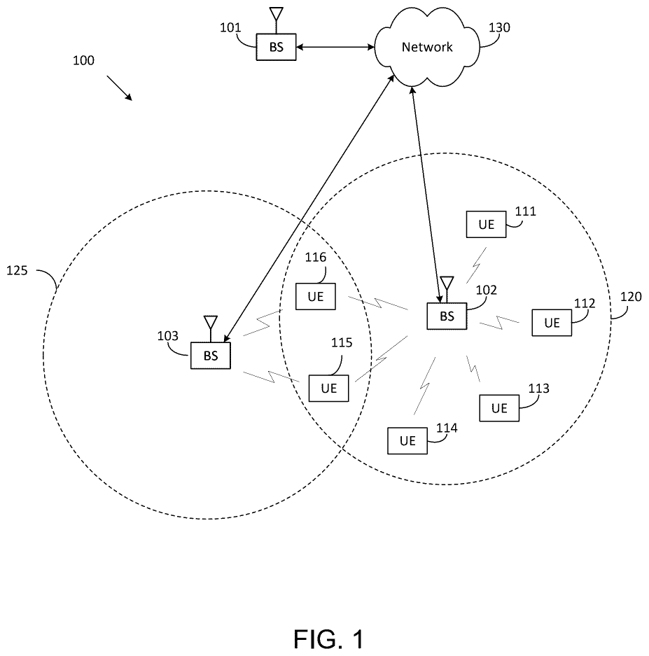

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for NN-based CE with varying input sizes. In certain embodiments, one or more of the gNBs 101-103 includes circuitry, programing, or a combination thereof, to support NN-based CE with varying input sizes in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

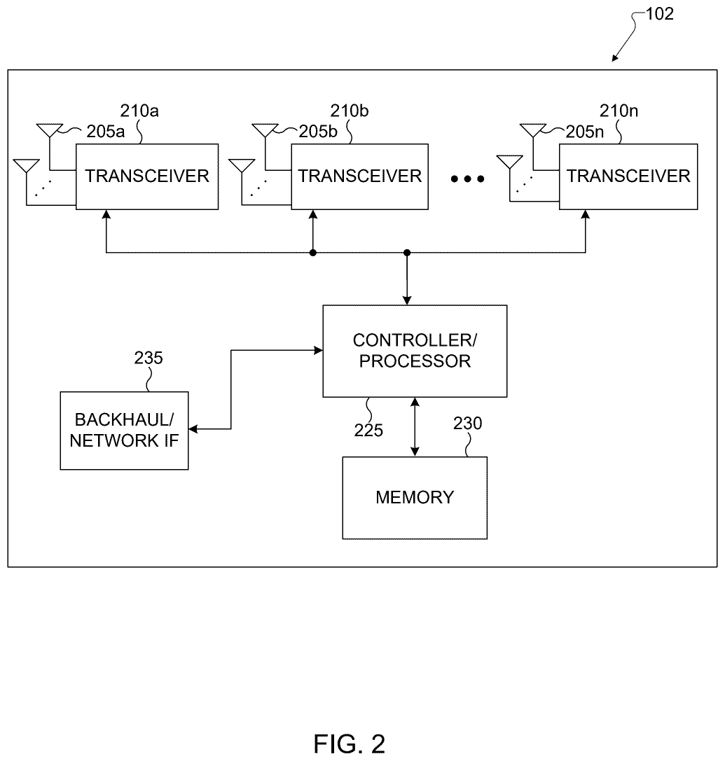

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support NN-based CE with varying input sizes as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

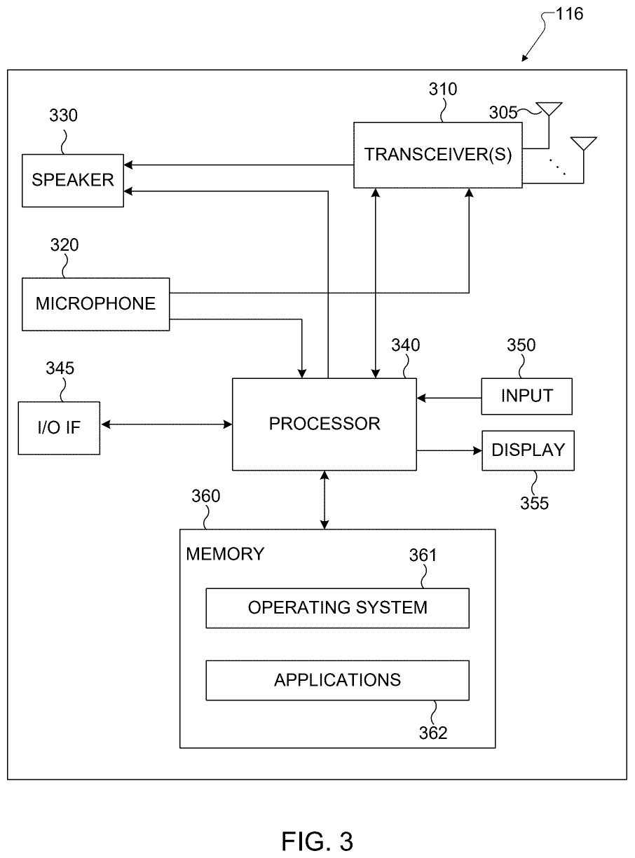

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for NN-based CE with varying input sizes as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

Channel estimation (CE) plays a critical role in ensuring reliable and efficient communications in wireless systems (such as wireless network 100 of FIG. 1), particularly in scenarios where the wireless channel conditions vary rapidly in an unpredictable manner. In practice, channel estimation often relies on pilot signals, which are known symbols to the receiver inserted into the transmitted signals, allowing the receiver to measure the channel response at specific times, frequencies, and/or spatial grids. The channel responses between pilot signals can be subsequently obtained using interpolation. In many cases, such as primary uplink shared channel (PUSCH) demodulation reference signal (DMRS) based uplink CE in LTE/NR wireless systems, the number of the DMRS symbols varies depending on several factors including UE channel bandwidth, subcarrier spacing, the number of antennas, and the number of resource blocks allocated. This leads to varying input sizes when performing channel estimation.

CE solutions including least squares (LS) based CE and linear minimum mean square error (LMMSE) CE are based on predetermined signal models and are susceptible to modeling errors. LS based CE solutions aim to minimize the squared error between the received signal and the estimated channel response, while LMMSE based CE solutions are more advanced compared to their LS estimation counterparts, targeting to improve estimation accuracy by taking into account the statistical properties of the channel and the noise. Both LS-based and LMMSE-based CE solutions assume a linear model of the received signals corrupted by additive noise.

Artificial intelligence (AI)/machine learning (ML) techniques may be used to develop channel estimation solutions. AI/ML-based channel estimation solutions, which adapt and learn from the wireless channel's characteristics using historical channel data, are capable of achieving superior estimation accuracy and are robust to modeling errors, varying channel conditions, and interference. In particular, deep neural networks (DNN), including multi-layer perceptron (MLP), convolutional neural networks (CNNs), and recurrent neural networks (RNNs) may be utilized in advanced CE solutions. These neural networks can learn complex relationships between received signals and channel characteristics, allowing for accurate and efficient estimation. Certain AI models, such as MLP neural network (NN) models, are designed with a fixed input size assumption, using multiple AI models to handle varying input sizes. This results in increased model storage utilization and higher system complexity. In contrast, by leveraging the convolution operation, CNNs can naturally accommodate input images of varying height and width. Meanwhile, due to the recurrent structure that RNNs have, RNNs can perform inferences on data with different sequence lengths without any modification. Additionally, RNNs can inherently accommodate varying input sizes within their network architectures. However, despite this flexibility, varying input sizes can potentially degrade the CE accuracy significantly if these AI models are not trained and tuned properly.

Various embodiments of the present disclosure may provide for channel estimation with varying input sizes for orthogonal frequency division multiplexing (OFDM)-based wireless communication systems. OFDM is a modulation technique widely used in many communication systems such as LTE or NR. In an OFDM-based communication system, an available frequency band is divided into evenly spaced orthogonal subcarriers that are modulated independently for data transmission. At each subcarrier, the frequency response can be approximated as flat. In other words, the channel coefficient at each subcarrier is approximated as a constant. Additionally, in many OFDM-based communication systems such as LTE/NR, time-frequency resources are divided into a time-frequency grid. The smallest time-frequency grid in LTE/NR is termed as a resource element (RE) that comprises one subcarrier in the frequency domain and one OFDM symbol in the time domain. Some subcarriers are allocated to transmit pilot signals, which are known at a receiver, for channel estimation. These subcarriers may also be referred to as pilot tones.

Various embodiments of the present disclosure may provide for channel estimation in OFDM systems using AI/ML techniques. Mathematically, the input-output relationship between transmitted and received signals at pilot tones in the frequency domain can be expressed as:

$${Y}_{p} = {H}_{p} ∘ {X}_{p} + {W}_{p} , \qquad Eq . ( l )$$

where Yₚ∈ [symbol] ^{N}^{_{pf}}^{×N}^{ₚₙ} are the received signals at pilot tones (subcarriers) across either antenna or time domains, Hₚ∈ [symbol] ^{N}^{_{pf}}^{×N}^{ₚₙ} denotes the channel matrix across either antenna or time (OFDM symbols) domains, the operator ∘ represents the Hadamard product that is an element-wise product, Xₚ∈ [symbol] ^{N}^{_{pf}}^{×N}^{ₚₙ} are the transmitted pilot signals known to the receiver, and Wₚ∈ [symbol] ^{N}^{_{pf}}^{×N}^{ₚₙ} is an additive white Gaussian noise (AWGN). Note that in a single input-multiple output (SIMO) uplink signal model, Nₚₙ can be used to represent the number of the received antennas, while in a single input-single output (SISO) case, Nₚₙ can be used to represent the number of the OFDM symbols containing pilot tones, respectively. Without loss of generality, for the sake of notational simplicity, the present disclosure replaces Nₚₙ with Nₐₙₜ, which refers to the number of received antennas.

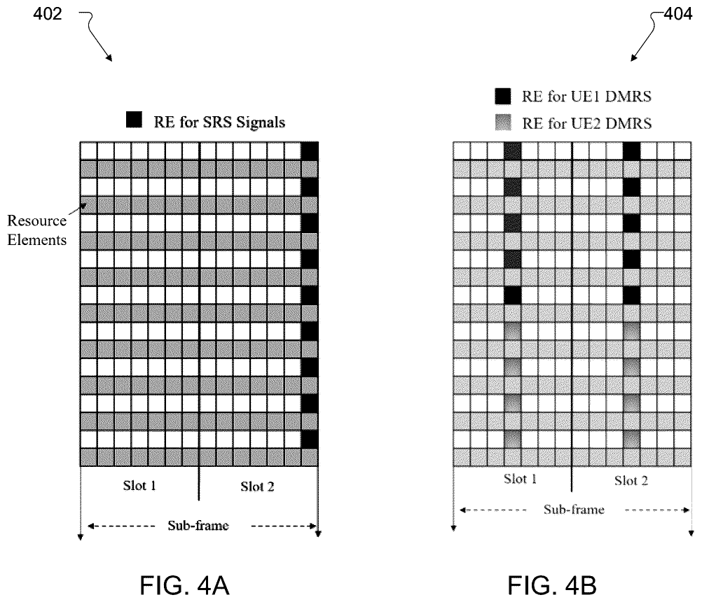

Sounding reference signals (SRSs) in LTE/NR are an example of one type of uplink pilot signals transmitted from a UE, which can be used by an eNodeB/gNodeB to estimate the uplink channel quality over a bandwidth of interest. SRS channel estimation can be used to assist the eNodeB/gNodeB uplink scheduler for UE resource allocation and to improve DL beamforming. PUSCH DMRSs are another type of reference signals used for channel estimation and demodulation of uplink data. Example SRS and DMRS signals are shown in FIGS. 4A-4B.

FIGS. 4A-4B illustrate examples of uplink pilot signals 402 and 404 according to embodiments of the present disclosure. The embodiments of uplink pilot signals of FIGS. 4A-4B are for illustration only. Different embodiments of uplink pilot signals could be used without departing from the scope of this disclosure.

FIG. 4A shows and example of a full-band SRS signal 402 which has a comb factor of 2. FIG. 4B shows an example of a full-band DMRS signal 404 which also has a comb factor of 2.

Although FIGS. 4A-4B illustrate examples of uplink pilot signals 402 and 404, various changes may be made to FIGS. 4A-4B. For example, various changes to the comb factor, the number of slots per sub-frame, the number of resource elements per slot, etc. could be made according to particular needs.

The goal of the channel estimation task is to estimate a channel matrix Hₚ based on a pilot signal Xₚ and a received signal Yₚ. One simple channel estimation solution is LS estimation, previously discussed above. LS estimates of Hₚ, denoted by

$${\hat{H}}_{p}^{LS}$$

can be readily computed as

$${[ {\hat{H}}_{p}^{LS} ]}_{i , j} = \frac{{[ {Y}_{p} ]}_{i , j}}{{[ {X}_{p} ]}_{i , j}}$$

where the subscript i, j denotes the (i, j)th entry of a matrix. Without loss of generality, the present disclosure assumes that the entries of Xₚ are equal to 1 and LS estimates of Hₚ can be simply written as

$${\hat{H}}_{p}^{LS} = {H}_{p} + {W}_{p} .$$

where

$${\hat{H}}_{p}^{LS}$$

is a N_{pf}×Nₐₙₜ complex matrix. The real and imaginary parts of

$${\hat{H}}_{p}^{LS}$$

can be treated as noisy images, and correspondingly the real and imaginary parts of Hₚ can be treated as noiseless images. Thus, channel estimation can be formulated as an image denoising problem, where the inputs are noisy images (the real and imaginary parts of

$${\hat{H}}_{p}^{LS} )$$

and the outputs are denoised images (the real and imaginary parts of the estimated channels using AI models).

Note that the various embodiments of the present disclosure can be readily applied to cases where pilot signals Xₚ have non-unit values.

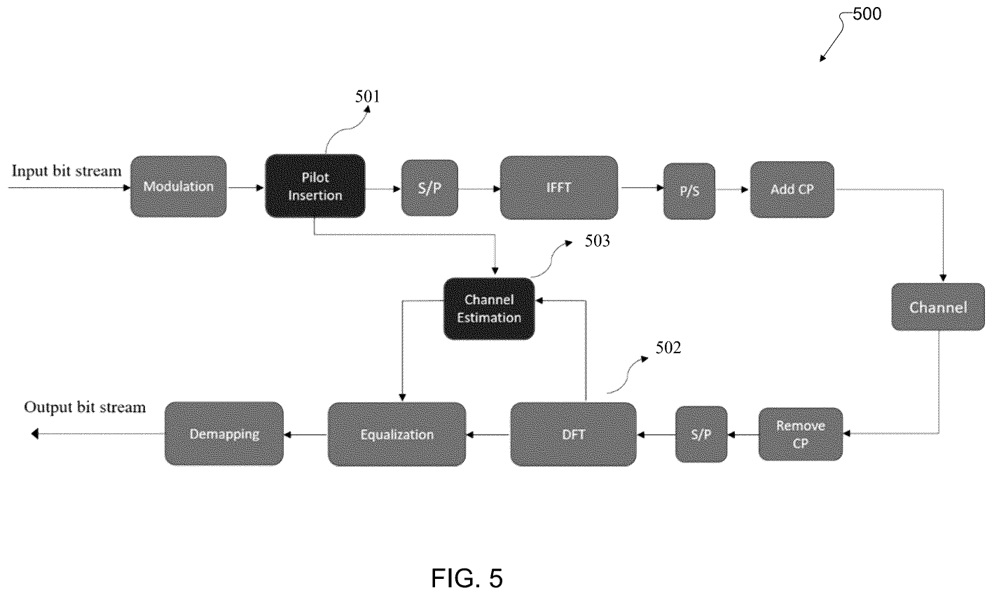

FIG. 5 illustrates an example cyclic prefix OFDM uplink system with a channel estimation model 500 according to embodiments of the present disclosure. The embodiment of a cyclic prefix OFDM uplink system with a channel estimation model of FIG. 5 is for illustration only. Different embodiments of a cyclic prefix OFDM uplink system with a channel estimation model could be used without departing from the scope of this disclosure.

FIG. 5 depicts the role of a channel estimation module in uplink cyclic prefix OFDM (CP-OFDM)-based PUSCH DMRS transmissions. In the example of FIG. 5, input bits are first grouped, and each group of the bits is then mapped into a modulation symbol (e.g. a complex number) by a modulation module. The output of the modulation module is a stream of modulation symbols. Via operation 501, pilot signals (symbols) such as DMRSs in time-frequency grids are generated and positioned in the modulation symbol stream. After a series of operations, a DFT module outputs received signals Yₚ in the frequency-antenna (FA) domain in operation 502. In operation 503, the received signals Yₚ at pilot tones in the FA domain along with known pilot signals indicated in operation 501 are input to the channel estimation module, which includes at least one AI/ML model for determining a channel estimation. The channel estimation module then provides a channel estimation based on the input.

Although FIG. 5 illustrates one example cyclic prefix OFDM uplink system with a channel estimation model 500, various changes may be made to FIG. 5. For example, the uplink system of FIG. 5 could be changed to apply to other types of uplink modulation such as uplink DFT spread OFDM (DFT-s-OFDM), etc. according to particular needs.

As noted above, channel estimation is a critical task in wireless communication systems, where the goal is to accurately estimate the channel characteristics to enable reliable data transmission. Some channel estimation methods may rely on signal processing techniques, which often struggle in complex environments such as those with high mobility or severe multipath effects. Machine learning can serve as a powerful tool for channel estimation, offering the ability to model complex, nonlinear relationships in the wireless channel. Machine learning models (particularly deep learning architectures) can be trained to learn the channel characteristics from pilot signals, leading to more accurate and efficient estimations, even in challenging scenarios. These models can adapt to changing environments, reduce the reliance on pilot signals, and improve the overall performance of the communication system. As a result, integrating machine learning into channel estimation is a useful approach in modern wireless networks, including 5G and beyond.

Receivers in wireless communication systems may face constraints on computational resources, particularly in performing floating-point operations during model inference. In some embodiments, an input signal to a model can have dimensions of 1×N_{pf}×Nₐₙₜ×2, where N_{pf} represents the number of pilot frames and Nₐₙₜ denotes the number of antennas. One strategy to manage these constraints is to divide the input tensor into smaller chunks and process each chunk sequentially. This chunking can be done along the pilot dimension, the antenna dimension, or a combination of both. The size of the chunk may vary during inference depending on the exact scenarios/constraints. Therefore, the ability for an ML model to generalize the varying input size is beneficial for such a use case. However, some machine learning approaches, such as MLPs, are not well-suited to this setup, as they struggle with varying input sizes during inference. To address this issue, various embodiments of the present disclosure may provide machine learning models along with a specialized training framework designed to handle these resource constraints.

In some embodiments, Recurrent Neural Networks (RNNs) may be utilized as part of an AI/ML model for channel estimation. RNNs are a class of artificial neural networks designed for sequenced data. Unlike some feedforward neural networks, RNNs have connections that allow information to persist across different steps in a sequence. This capability makes RNNs particularly suitable for tasks where context and temporal dynamics are important, such as time series analysis, natural language processing, and signal processing. RNNs process sequences of data one step at a time, maintaining a hidden state that captures information from previous steps. The same weights are used for all steps in the sequence, enabling the model to generalize across different positions in the sequence. During training, RNNs leverage Backpropagation Through Time (BPTT), which unrolls the network through time to compute gradients.

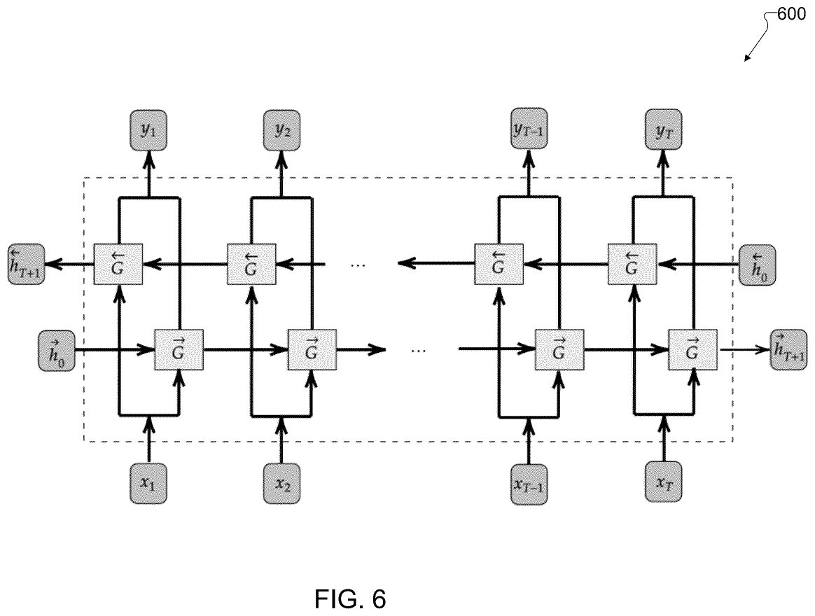

Although RNNs have achieved numerous accomplishments, they can only leverage information in a unidirectional fashion. In particular, RNNS only have access to the past information prior to current time step. Applications like language modeling, signal denoising, and seq2seq translations expect the model to be able to take bidirectional information. Bidirectional Recurrent Neural Networks (BRNNs) extend standard RNNs by processing the input sequence in both forward and backward directions. This allows the network to have both past and future information at every time step. BRNNs maintain two hidden states per time step-one for forward processing the sequence and one for backward processing the sequence. By leveraging information from both directions, BRNNs can capture more contextual information, leading to improved performance in tasks where understanding the context from both the past and future is crucial. A diagram of an example BRNN is shown in FIG. 6.

FIG. 6 illustrates an example BRNN 600 according to embodiments of the present disclosure. The embodiment of a BRNN of FIG. 6 is for illustration only. Different embodiments of a BRNN could be used without departing from the scope of this disclosure.

A standard RNN considers only a single directional input:

$${y}_{t} = f ( {x}_{1} , … , {x}_{t - 1} , {x}_{t} )$$

A standard RNN may be used if at time step t, only the previous time-steps' inputs are available. In the example of FIG. 6, it is presumed that at a pilot location t, both the previous inputs (x₁, . . . , xₜ) as well as the inputs after pilot location t (xₜ₊₁, . . . , xₙ) are available. That is to say, the BRNN 600 considers bidirectional inputs:

$${y}_{t} = f ( {x}_{1} , … , {x}_{t - 1} , {x}_{t} , {x}_{t + 1} , … , {x}_{n} )$$

The use of inputs in both directions better leverages the correlations over the pilot dimensions.

BRNN 600 leverages two transition functions:

The forward function ƒ_{→}: (x, [symbol] ₜ) [symbol] ₜ₊₁ and the backward function ƒ_{←}: (x, [symbol] ₜ) [symbol] ₜ₋₁.

These functions maintain two sets of states:

forward states [symbol] ₜ and backward states [symbol] ₜ.

To obtain the final output, an output function is used by taking both the forward state and backward state of the current time step as input:

$${o}_{t} = {f}_{0} ( {\vec{G}}_{t} , {{G}^{↼}}_{t} )$$

Although FIG. 6 illustrates one example BRNN 600, various changes may be made to FIG. 6. For example, various changes to the number of time steps, etc. could be made according to particular needs.

Some RNNs suffer from a vanishing gradient problem, where gradients propagated through many time steps can become extremely small, preventing the network from learning long-term dependencies effectively. This issue limits the capability of RNNs to retain information over long sequences. The introduction of gating mechanisms in Long Short-Term Memory (LSTM) networks and Gated Recurrent Unit (GRU) networks can be used to overcome this limitation. Gating mechanisms allow the network to control the flow of information, enabling better handling of dependencies across different time steps.

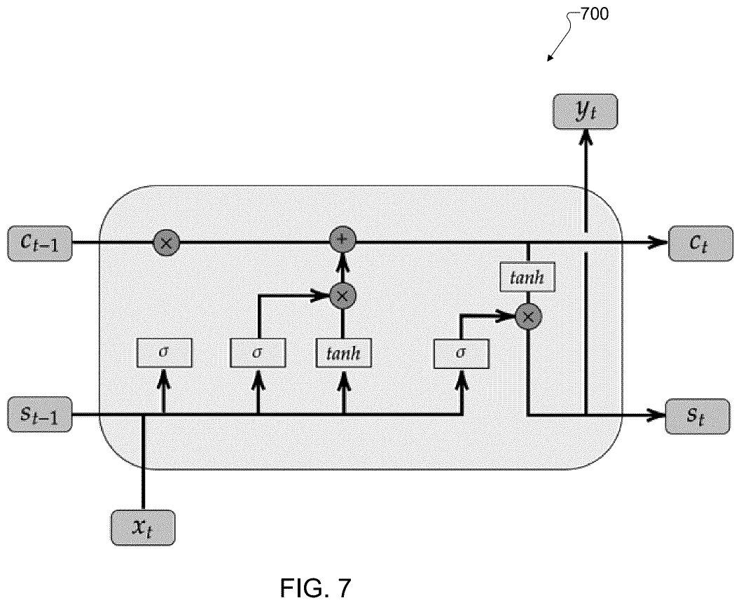

LSTMs introduce a cell state that runs through the entire sequence, providing a pathway for gradients to flow without vanishing. LSTMs use three gates—an input gate, a forget gate, and an output gate—to regulate the cell state and the hidden state. GRUs simplify the LSTM architecture by combining the forget and input gates into a single update gate and using a reset gate to control the flow of information. The update gate decides how much of the past information needs to be passed along to the future, while the reset gate determines how much of the past information to forget. Compared to LSTM networks, GRUs have a simpler architecture with fewer parameters, which can make GRU networks faster to train and easier to implement. GRUs have been shown to perform comparably to LSTMs on many tasks while being computationally more efficient. A diagram of an example GRU is shown in FIG. 7.

FIG. 7 illustrates an example GRU 700 according to embodiments of the present disclosure. The embodiment of a GRU of FIG. 7 is for illustration only. Different embodiments of a GRU could be used without departing from the scope of this disclosure.

In the example of FIG. 7, GRU 700 utilizes an update gate to determine how much of a previous state to pass to the next state zₜ, where:

$${z}_{t} = σ ( {W}_{z} {x}_{t} + {U}_{z} {h}_{t - 1} + {b}_{z} )$$

GRU 700 also utilizes a reset gate to determine how much of a previous state rₜ to ignore, where:

$${r}_{t} = σ ( {W}_{r} {x}_{t} + {U}_{r} {h}_{t - 1} + {b}_{r} )$$

GRU 700 combines the current input and the previous hidden state to create a candidate hidden state \tilde{h}ₜ, where:

$${\tilde{h}}_{t} = tanh ( {W}_{h} {x}_{t} + {U}_{h} ( {r}_{t} ⊙ {h}_{t - 1} ) + {b}_{h} )$$

Finally, GRU 700 Interpolates between the previous hidden state and the candidate hidden state to determine the current hidden state hₜ, where:

$${h}_{t} = ( 1 - {z}_{t} ) ⊙ {h}_{t - 1} + {z}_{t} ⊙ {\tilde{h}}_{t}$$

Although FIG. 7 illustrates one example GRU 700, various changes may be made to FIG. 7. For example, various changes to update and reset gates could be made, etc. according to particular needs.

Various embodiments of the present disclosure may combine a BRNN structure with a GRU as the recurrent unit. Namely, the forward and backward states of the BRNN are updated through GRUs. This structure is referred to herein as a BRNN-GRU structure. Various embodiments of the present disclosure may leverage a BRNN-GRU structure to perform channel estimation.

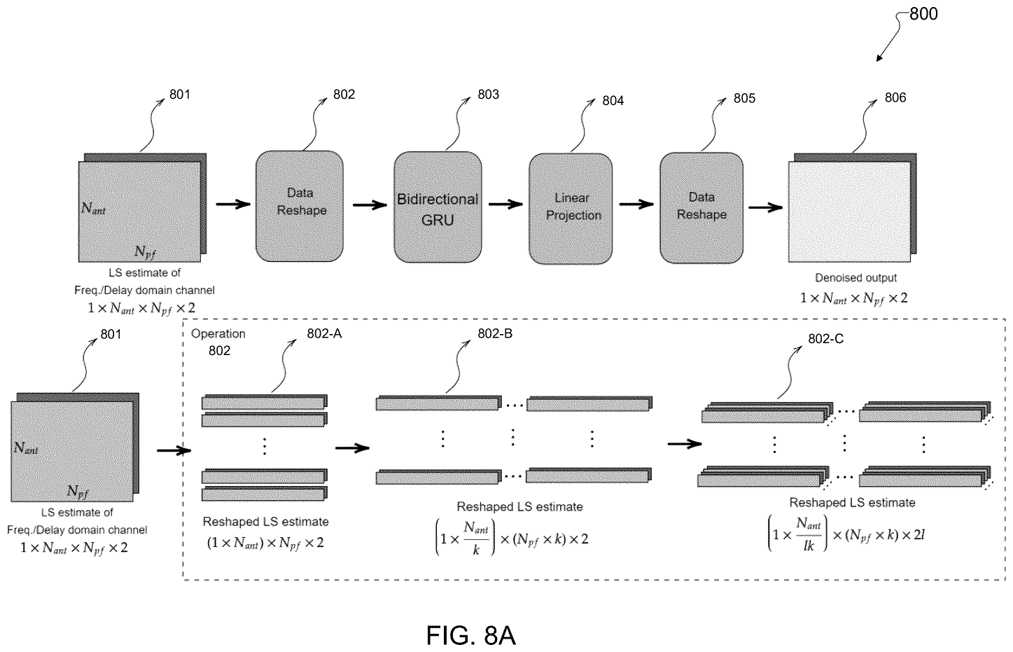

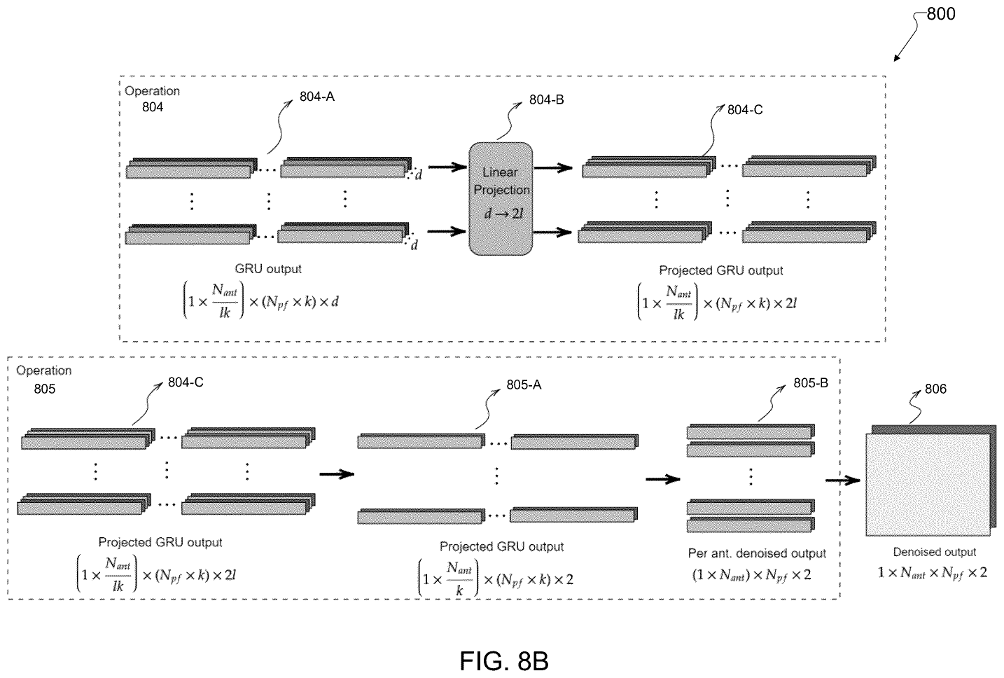

FIGS. 8A-8B illustrate an example BRNN-GRU based process for CE 800 according to embodiments of the present disclosure. An embodiment of the process illustrated in FIGS. 8A-8B is for illustration only. One or more of the components illustrated in FIGS. 8A-8B may be implemented in specialized circuitry configured to perform the noted functions or one or more of the components may be implemented by one or more processors executing instructions to perform the noted functions. Other embodiments of a BRNN-GRU based process for CE could be used without departing from the scope of this disclosure.

In the example of FIGS. 8A-8B, the channel estimation process begins in operation 801. In operation 801, an LS estimate

$${\hat{H}}_{p}^{LS}$$

of Hₚ is obtained from Yₚ. In the example of FIGS. 8A-8B, the LS estimate

$${\hat{H}}_{p}^{L S}$$

is exemplified with size 1×Nₐₙₜ×N_{pf}×2 in the FA domain with 2 referring to the real and imaginary parts of the wireless channels. However, it should be understood that the BRNN-GRU based process for CE 800 of FIGS. 8A-8B is not limited to this particular size example of an LS estimate

$${\hat{H}}_{p}^{LS} .$$

In some embodiments, the noisy signals

$${\hat{H}}_{p}^{LS}$$

in the FA domain can be optionally converted to the delay domain using a discreet Fourier transform (DFT).

After obtaining the LS estimate

$${\hat{H}}_{p}^{LS} ,$$

a reshape operation 802 is performed to reshape

$${\hat{H}}_{p}^{LS}$$

to size

$$( 1 \times \frac{{N}_{a n t}}{lk} ) \times ( {N}_{pf} \times k ) \times 2 l .$$

This is achieved by first reshaping

$${\hat{H}}_{p}^{LS}$$

into size (1×Nₐₙₜ)×N_{pf}×2 in operation 802-A, treating each antenna as an individual sequence of length N_{pf} with 2 input features at each carrier. Then for every k antennas, the k sequences are concatenated to form a sequence of length N_{pf}×k, which gives a data tensor of size

$$( 1 \times \frac{{N}_{a n t}}{k} ) \times ( {N}_{pf} \times k ) \times 2 ,$$

as shown in operation 802-B, where k is an integer and is divisible by Nₐₙₜ. Then

$$\frac{{N}_{a n t}}{lk}$$

chunks of size (1×l)×(N_{pf}×k)×2 are formed by splitting the first dimension of the data tensor every l examples. Finally, these chunks are reshaped into size (1)×(N_{pf}×k)×2l and concatenated along the first dimension, reaching a final data tensor of size

$$( 1 \times \frac{{N}_{a n t}}{lk} ) \times ( {N}_{pf} \times k ) \times 2 l ,$$

where l is an integer and lk is divisible by Nₐₙₜ, as shown in operation 802-C. Note the above shape considers only one example of the LS estimate

$${\hat{H}}_{p}^{LS} .$$

For a batch of LS estimates of size N, the above shape should be

$$( N \times \frac{{N}_{a n t}}{lk} ) \times ( {N}_{pf} \times k ) \times 2 l .$$

In operation 803, the reshaped sequences are then fed into bidirectional GRU networks, which are based on the bidirectional RNN structure illustrated in FIG. 6, where each of the recurrent units is replaced with the GRU as shown in FIG. 7. The bidirectional RNN will map the sequences into size

$$( 1 \times \frac{{N}_{a n t}}{lk} ) \times ( {N}_{pf} \times k ) \times d ,$$

where d is the hidden state size of the BRNN. In operation 804, first a linear projection (operation 804-B) is used to project the feature dimension into 2, reaching an output of size

$$( 1 \times \frac{{N}_{a n t}}{k} ) \times ( {N}_{pf} \times k ) \times 2$$

(operation 804-C). Finally, a reshaping is performed in operation 805, which is the inverse of operation 802 to obtain the final denoised signals of shape 1×Nₐₙₜ×N_{pf}×2 in operation 806.

In some embodiments, ‘genie’ channel data is collected as labeled data and the model is trained in a supervised learning manner.

In some embodiments, where ‘genie’ channel data is unavailable, the ‘genie’ channel data is replaced by high signal-to-noise ratio (SNR) data as noisy labels using for training the model.

Although FIGS. 8A-8B illustrate one example BRNN-GRU based process for CE 800, various changes may be made to FIGS. 8A-8B. For example, while shown as a series of steps, various steps in FIGS. 8A-8B could overlap, occur in parallel, occur in a different order, occur any number of times, be omitted, or replaced by other steps.

Residual Network (ResNet), refers to a deep learning architecture introduced to address the problem of vanishing gradients that often occurs when training very deep neural networks. ResNet introduces residual blocks, which allow the network to learn residual functions with reference to the layer inputs rather than trying to learn unreferenced functions. Each residual block includes shortcut connections that bypass one or more layers, enabling the network to learn identity mappings. This architecture allows very deep networks to be trained efficiently by mitigating the degradation problem, where increasing depth leads to higher training error. ResNet enables the construction of extremely deep networks, such as ResNet-50, ResNet-101, and even deeper without suffering from vanishing gradients, leading to improved accuracy in complex tasks. ResNet can be employed in various applications, including image classification, object detection, and image denoising/restoration. Various embodiments of the present disclosure may utilize ResNet to perform channel estimation.

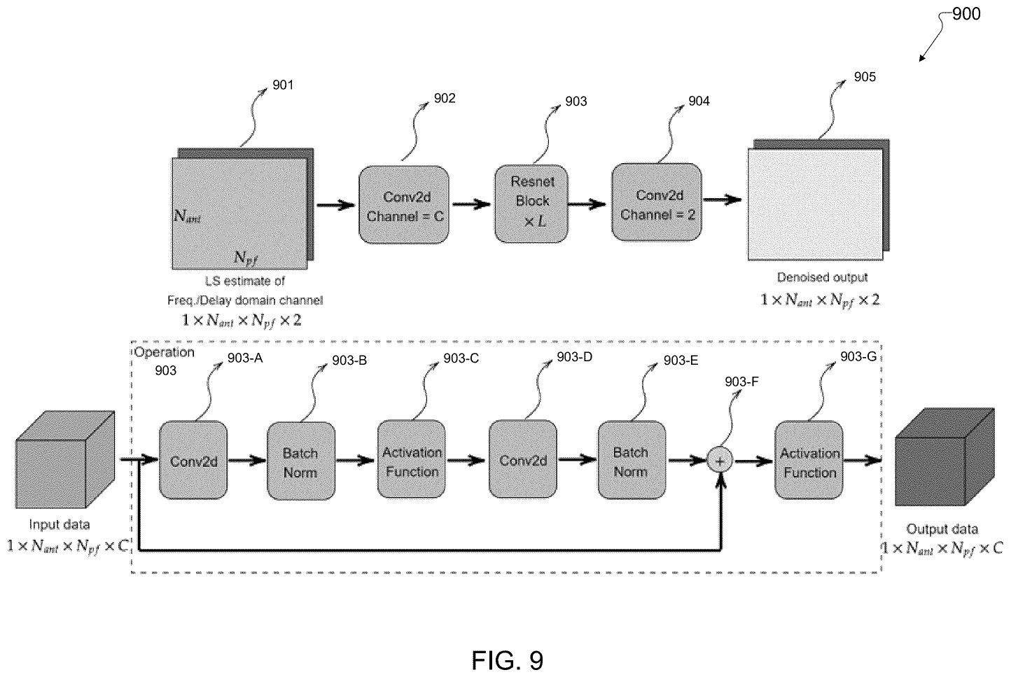

FIG. 9 illustrates an example ResNet based process for CE 900 according to embodiments of the present disclosure. An embodiment of the process illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a ResNet based process for CE could be used without departing from the scope of this disclosure.

In the example of FIG. 9, the channel estimation process begins in operation 901. In operation 901, an LS estimate

$${\hat{H}}_{p}^{LS}$$

of Hₚ is obtained from Yₚ. In the example of FIG. 9, the LS estimate

$${\hat{H}}_{p}^{LS}$$

is exemplified with size 1×Nₐₙₜ×N_{pf}×2 in the FA domain with 2 referring to the real and imaginary parts of the wireless channels. However, it should be understood that the ResNet based process for CE 900 of FIG. 9 is not limited to this particular size example of an LS estimate

$${\hat{H}}_{p}^{LS} .$$

In some embodiments, the noisy signals

$${\hat{H}}_{p}^{LS}$$

in the FA domain can be optionally converted to the delay domain using a discreet Fourier transform (DFT).

In operation 902,

$${\hat{H}}_{p}^{LS}$$

is projected to channel size c using standard 2D convolution layers.

In operation 903, various numbers of ResNet blocks having the architecture illustrated in the detailed view of operation 903 shown in FIG. 9 are stacked. The input data is fed through a series of 2D convolution, batch-normalization as well as activation layers, through operations 903-A to 903-E. After, the skip connection is applied in operation 903-F to obtain the sum of the layer input and the output features of 903-E. This sum is subsequently fed into the activation function 903-G, and the output of the ResNet block is obtained.

Finally, in operation 904, another 2D convolution layer is applied to the output of operation 903 to project the channel dimension back to size 2 to recover the denoised signals 905.

Although FIG. 9 illustrates one example ResNet based process for CE 900, various changes may be made to FIG. 9. For example, while shown as a series of steps, various steps in FIG. 9 could overlap, occur in parallel, occur in a different order, occur any number of times, be omitted, or replaced by other steps.

U-Network (U-Net) refers to a convolutional neural network architecture originally designed for biomedical image segmentation. The architecture is notable for its U-shaped design, which includes a contracting path to capture context and a symmetric expanding path that enables precise localization. U-Net's architecture can be roughly divided into four parts: contracting path, bottleneck, expanding path and the final output layer.

The contracting path, also known as the encoder, is responsible for capturing the context of the input image through a series of convolutional and downsampling operations. The contracting path comprises the following layers:
1) Convolutional Layers: Each block in the contracting path contains two convolutional layers with rectified linear unit (ReLU) activation functions. These layers increase the depth of the feature maps, allowing the network to learn more complex features.
2) Max Pooling Layers: Following each convolutional block, a max pooling layer with a stride of 2 is used to downsample the feature maps. This reduces the spatial dimensions by a factor of two, which helps the network to focus on larger and more abstract features.
3) Channel Doubling: With each downsampling step, the number of feature channels is doubled, starting from an initial number (e.g., 64) and increasing progressively (e.g., 128, 256, 512). This helps the network to learn a rich hierarchy of features.

At the bottom of the U-shaped architecture, the bottleneck serves as a bridge between the contracting and expanding paths. The bottleneck comprises a convolutional layer with two 3×3 convolutional layers with ReLU activations, similar to the layers in the encoder. Additionally note that the feature maps at the bottleneck have the highest number of channels (e.g., 1024), allowing the network to capture the most abstract features.

The expanding path, also known as the decoder, is responsible for reconstructing the spatial resolution of the input image and producing the final segmentation map. The expanding path comprises the following layers:
1) Up-convolutional (Transposed Convolution) Layers: Each block in the expanding path begins with a transposed convolution (also known as upsampling or deconvolution) layer, which doubles the spatial dimensions of the feature maps.
2) Concatenation Layers: The feature maps from the corresponding layer in the contracting path are concatenated with the upsampled feature maps. This skip connection helps the network to retain high-resolution information that was lost during downsampling.
3) Convolutional Layers: Following each concatenation, two convolutional layers with ReLU activations are applied. These layers refine the upsampled feature maps and integrate the information from the corresponding encoder layers.

The final layer of the U-Net architecture is a convolutional layer that reduces the number of feature channels to the desired number of classes for the segmentation task. For binary segmentation, this layer outputs a single channel with a sigmoid activation function, whereas for multi-class segmentation, it outputs multiple channels with a softmax activation function.

One of the key features of U-Net is the use of skip connections between the contracting and expanding paths. These connections concatenate the feature maps from the encoder with those of the decoder at each corresponding level, allowing the network to use both the high-level contextual information from the bottleneck and the low-level spatial information from the encoder. This helps to produce more accurate and detailed segmentations, especially for small and fine structures.

Various embodiments of the present disclosure may utilize an architecture similar to U-Net to perform channel estimation. In these embodiments, the architecture may differ from U-Net by removing all the pooling layers. Instead, downsampling is performed by using 2D convolution with strides. Experimentation has shown that in practice, when performing denoising tasks, pooling layers are often detrimental to the final results. The architecture may further differ from U-Net by removal the softmax activation at the end of the output layer. However, channel estimation processes and techniques utilizing a modified U-Net architecture may still be described herein as U-Net based.

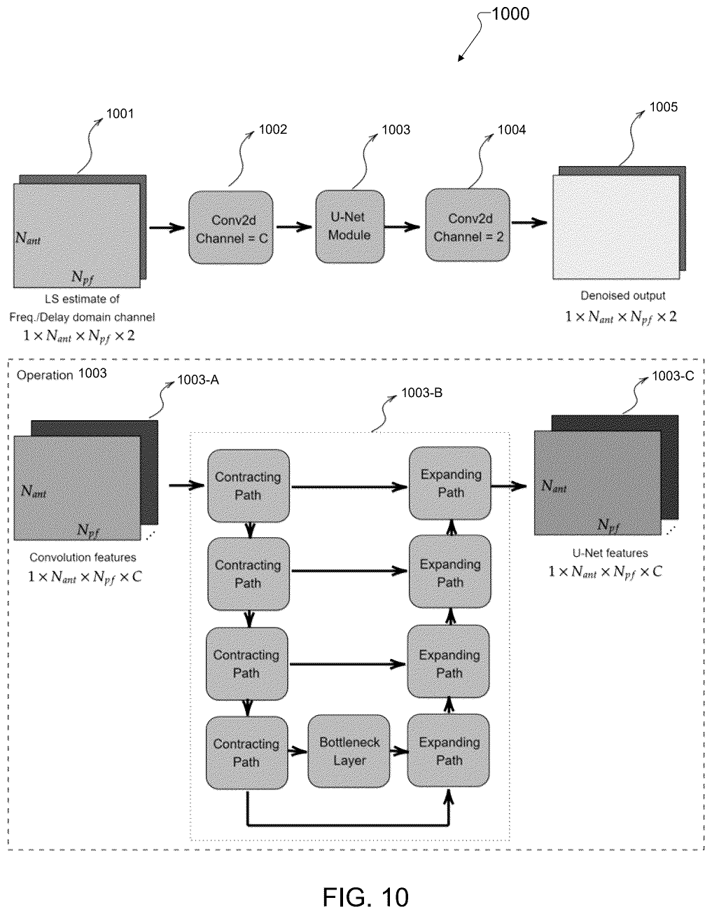

FIG. 10 illustrates an example U-Net based process for CE 1000 according to embodiments of the present disclosure. An embodiment of the process illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a U-Net based process for CE could be used without departing from the scope of this disclosure.

In the example of FIG. 10, the channel estimation process begins in operation 1001. In operation 1001, an LS estimate

$${\hat{H}}_{p}^{LS}$$

of Hₚ is obtained from Yₚ. In the example of FIG. 10, the LS estimate

$${\hat{H}}_{p}^{LS}$$

is exemplified with size 1×Nₐₙₜ×N_{pf}×2 in the FA domain with 2 referring to the real and imaginary parts of the wireless channels. However, it should be understood that the U-Net based process for CE 1000 of FIG. 10 is not limited to this particular size example of an LS estimate

$${\hat{H}}_{p}^{LS} .$$

In some embodiments, the noisy signals

$${\hat{H}}_{p}^{LS}$$

in the FA domain can be optionally converted to the delay domain using a discreet Fourier transform (DFT).

In operation 1002,

$${\hat{H}}_{p}^{LS}$$

is projected to channel size c using a standard 2D convolution layers.

In operation 1003, a U-Net module is employed to obtain the intermediate features. In this example, the U-Net module is based on a modified U-Net architecture similar as described above, where the pooling layers are replaced by 2D convolution with strides, and the softmax activation at the end of the output layer is removed. In the example of FIG. 10 operation 1003 is illustrated where the modified U-Net architecture shown in operation 1003-B includes four contracting paths and four expanding paths. However, it should be understood that the U-Net based process for CE 1000 may utilize a modified U-Net architecture that includes any number of contracting and expanding paths.

Finally, in operation 1004, another 2D convolution layer is applied to the output of operation 1003 to project the channel dimension back to size 2 to recover the denoised signals 1005.

Although FIG. 10 illustrates one example U-Net based process for CE 1000, various changes may be made to FIG. 10. For example, while shown as a series of steps, various steps in FIG. 10 could overlap, occur in parallel, occur in a different order, occur any number of times, be omitted, or replaced by other steps.

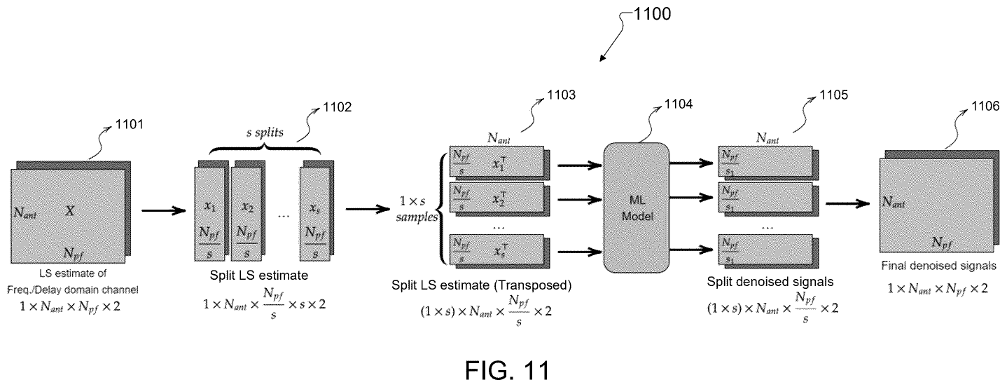

The models employed in the channel estimation processes described herein (i.e., BRNN-GRU based, ResNet based, and/or U-Net based) are capable of inferencing given an input chunk of arbitrary size (albeit in the channel dimension). When training the models, a lack of different sizes of training data tends to result in a discrepancy between the training set distribution and a testing set distribution. This may void some especially long-range dependencies that the model has captured, and decrease the model's performance on the testing set. This discrepancy can be seen by testing the model's performance on a split dataset. For example, split data testing as shown in FIG. 11 may be performed on the model to show the discrepancy.

FIG. 11 illustrates an example process for split data testing 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for split data testing could be used without departing from the scope of this disclosure.

In the example of FIG. 11, the process for split data testing 1100 begins in operation 1101. In operation 1101, test data X having a shape 1×Nₐₙₜ×N_{pf}×2 (which is of the same size as the training data) is provided.

In operation 1102 the test data is split on the carrier dimension, splitting N_{pf} carriers into s number of N_{pf}/p carriers x₁, . . . , xₛ.

In operation 1103, the split test data is transposed, forming a dataset of size

$$( 1 \times s ) \times {N}_{ant} \times \frac{{N}_{pf}}{s} \times 2$$

with (1×s) examples

$${x}_{1}^{T} , … , {x}_{s}^{T} .$$

In the example of FIG. 11, for operation 1103 the batch size is set to be 1. However, it should be understood that different batch sizes may be used. In operation 1103, for a batch size of N, there will be (N×s) split examples.

In operation 1104, the split examples are fed individually into the trained ML model (e.g., a BRNN-GRU based, ResNet based, or U-Net based model) to obtain the split denoised signals in operation 1105.

Finally, a reshaping operation is carried out in operation 1106 to obtain the final denoised signals of the original shape 1×Nₐₙₜ×N_{pf}×2.

Although FIG. 11 illustrates one example process for split data testing 1100, various changes may be made to FIG. 11. For example, while shown as a series of steps, various steps in FIG. 11 could overlap, occur in parallel, occur in a different order, occur any number of times, be omitted, or replaced by other steps.

One approach to avoid a discrepancy between the training and testing distribution as described above is to create multiple training sets containing the same data with different chunking schemes (for example splitting the data on the carrier dimension for different portions), then padding all of these training sets to the maximum size with special tokens (such as zeros) and using all of the padded data to train the model. Although this method simplifies the training process and enables efficient batch processing, it also introduces its own set of challenges, such as preventing the model from inadvertently learning from the padding tokens and managing the potential inefficiencies introduced by processing these non-informative elements. Moreover, depending on the needs at the inference time, creation of many of such “padded” datasets may be needed. This can lead to a drastic increase in memory utilization, resulting in high computational costs.

To overcome these issues, various embodiments of the present disclosure provide new training routines incorporating data tensors of various sizes. Such a data routine may be referred to herein as a split data training routine (SDTR). SDTRs can improve model testing performance on dynamically sized data. An SDTR as described herein chunks the data batches on the fly during training time, without needing to construct the chunked training sets a priori. An SDTR as described herein also does not rely on padding the data with special tokens, circumventing numerous issues that padding brings. An SDTR as described herein is a flexible framework, that can be used with various ML models capable of inferencing on data set of various sizes, such as RNN and CNN.

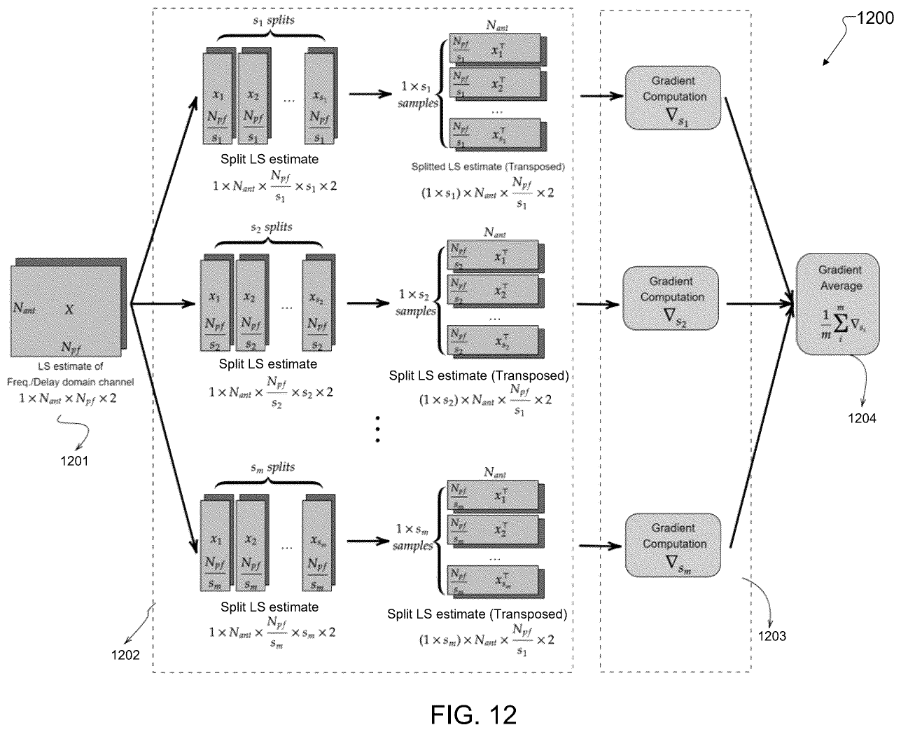

FIG. 12 illustrates an example split data training routine 1200 according to embodiments of the present disclosure. An embodiment of the split data training routing illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a split data training routine could be used without departing from the scope of this disclosure.

In the Example of FIG. 12, the SDTR is based on a carrier dimension size modification. However, variations on other dimensions can follow the same procedure, with slight differences on reshaping. In the Example of FIG. 12, the SDTR is performed in a batch-wise fashion. Namely for each gradient descent batch data (typically of size N×Nₐₙₜ×N_{pf}×2) the gradient is computed and an update is made to the ML model of interest. In the example of FIG. 12, N=1 is used as a special case.

STDR 1200 begins at in operation 1201. In operation 1201, An LS estimate of a channel of size 1×Nₐₙₜ×N_{pf}×2 is taken in as input.

In operation 1202, similar to operations 1102 and 1103 of FIG. 11, the data tensor is split along the carrier dimension into the desired number of splits s₁, s₂, . . . , sₘ, where sᵢ∈ [symbol] ⁺, N_{pf} mod sᵢ=0, ∀i∈[m], creating m sub-batches Bᵢ∀i∈[m], where Bᵢ is of size

$$\begin{matrix}( 1 \times {s}_{i} ) \times \\ {N}_{ant} \times \frac{{N}_{pf}}{{s}_{i}} \times 2 ,\end{matrix}$$

which transposed into samples

$${x}_{1}^{T} , … , {x}_{s}^{T} .$$

Subsequently, in operation 1203, the gradient with respect to a loss function L (B, θ) is computed, where the underlying ML model is parameterized by θ, obtaining the gradient with respect to each sub-batch Bᵢ,

$${∇}_{i} = \frac{\partial L ( {B}_{i} , θ )}{\partial {B}_{i}} .$$

Finally, in operation 1204, the final gradient update to the model is computed by averaging the gradient across all sub-batches, i.e.,

$$∇ = \frac{1}{m} {\sum }_{i}^{m} {∇}_{i} , ∀ i ∈ [ m ]$$

and updating the model parameter by gradient descent: θ_{new}=θ_{old}−α∇, where α is the learning rate. In some embodiments, a split number of 1 is included, indicating the original not-split dataset. Depending on the number of different splits considered, i.e., m, one might also want to decrease the batch size N to utilize fewer resources while training.

Although FIG. 12 illustrates one example split data training routine 1200, various changes may be made to FIG. 12. For example, while shown as a series of steps, various steps in FIG. 12 could overlap, occur in parallel, occur in a different order, occur any number of times, be omitted, or replaced by other steps.

The BRNN-GRU channel estimation process of FIGS. 8A-8B mainly considers the input data to be sequences of input dimension 2 (real and imaginary parts of the signal). Although the antenna-wise correlation is captured by operation 802-B, depending on the choice of k, the degree of the captured correlation varies. To better utilize antenna-wise correlation when using RNN-based solutions, one approach is to treat the input data as sequences of input dimension 2×Nₐₙₜ and directly apply BRNN-GRU based process for CE 800. However, in doing so, when dealing with large Nₐₙₜ, e.g., 64, the input dimensionality is greatly increased at each time step, and this increasement can lead to various challenges during training. One of the primary challenges in training RNNs is the vanishing and exploding gradient problem, which is exacerbated by large input dimensions. This issue becomes more pronounced with large input dimensions, as the gradients are propagated over a larger number of weights, leading to a rapid decay in their magnitude. As a result, the network fails to learn long-term dependencies (gradient vanishing) or observe high numerical instability and divergence (gradient explosion) during training. The model complexity of RNNs increases with the number of input dimensions as well. This can increase the risk of overfitting, especially when the training dataset is limited.

To circumvent the aforementioned issues, various embodiments of the present disclosure provide CNN feature powered RNN-based processes for CE, which leverage CNN to aggregate and compress information across antennas generating additional informative features. These CNN-derived features are then concatenated with each antenna's original features, creating a richer input for the BRNN-GRU pipeline shown in FIGS. 8A-8B. This integration enhances the model's ability to capture complex patterns across antennas while maintaining the efficiency of the original architecture, without introducing significant overhead for RNN's optimization.

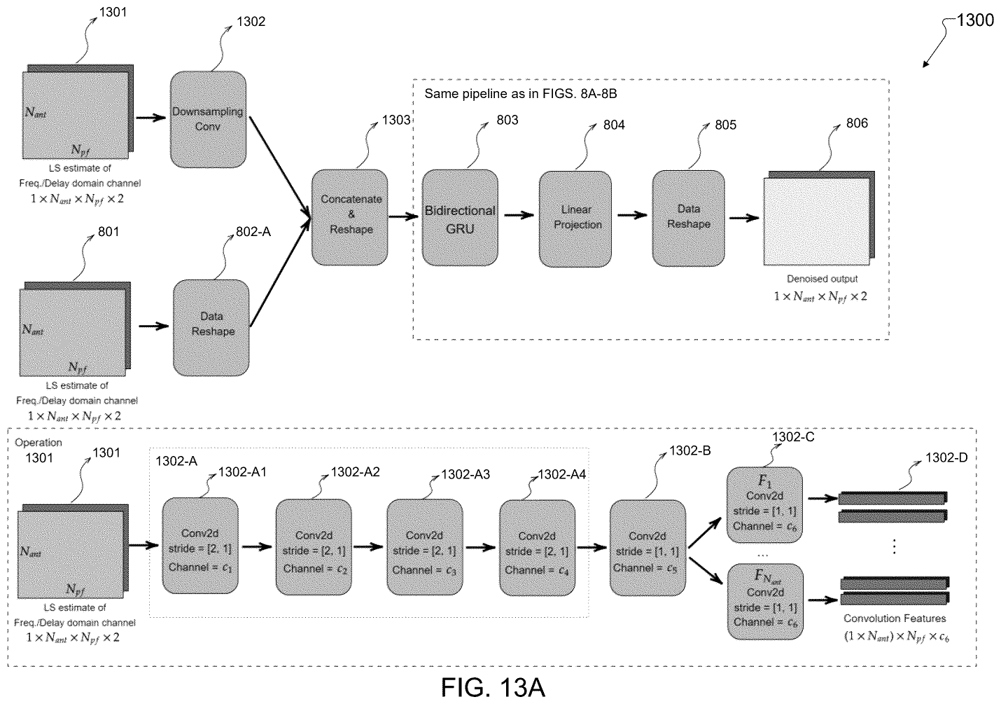

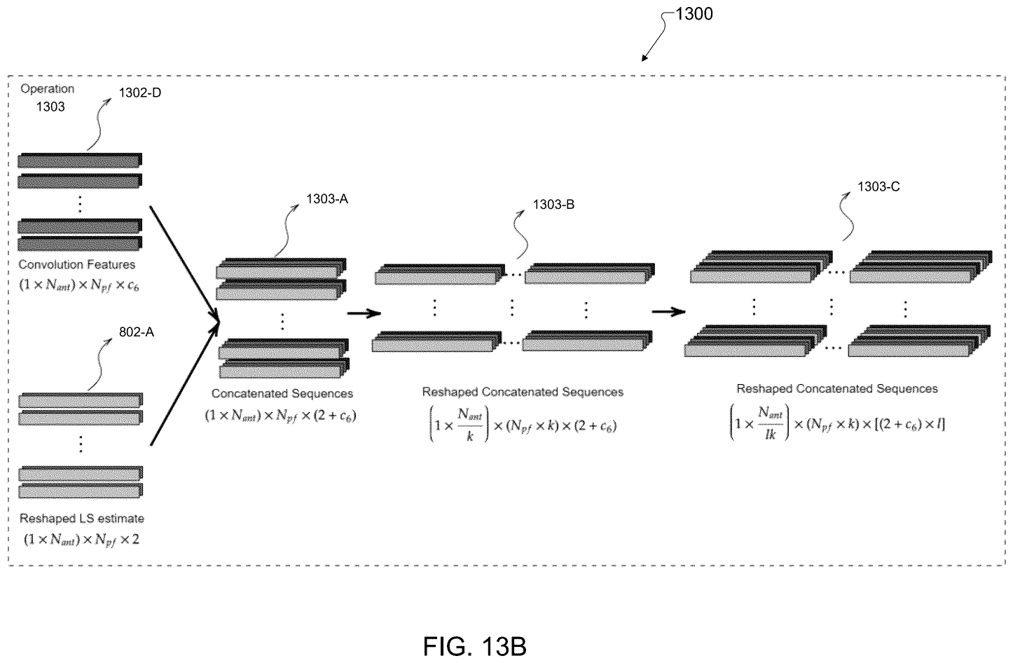

FIGS. 13A-13B illustrate an example CNN feature powered RNN-based process for CE 1300 according to embodiments of the present disclosure. An embodiment of the process illustrated in FIGS. 13A-13B is for illustration only. One or more of the components illustrated in FIGS. 13A-13B may be implemented in specialized circuitry configured to perform the noted functions or one or more of the components may be implemented by one or more processors executing instructions to perform the noted functions. Other embodiments of a CNN feature powered RNN-based processes for CE could be used without departing from the scope of this disclosure.

In the example of FIGS. 13A-13B, the channel estimation process begins in operation 1301, which is identical to operation 801 of FIGS. 8A-8B, where an LS estimate

$${\hat{H}}_{p}^{LS}$$

of Hₚ is obtained from Yₚ.

After obtaining the LS estimate

$${\hat{H}}_{p}^{LS} ,$$

a reshape operation identical to operation 802-A of FIGS. 8A-8B is performed on

$${\hat{H}}_{p}^{LS} .$$

Then to obtain the CNN extracted features,

$${\hat{H}}_{p}^{LS}$$

is fed into a series of downsampling operations in operation 1302. These downsampling operations are performed using 2D convolution layers with 2 strides on the antenna dimension (operation 1302-A). Note the strided convolutions are done only on the antenna dimension, which will shrink the number of antennas but will not impact the carrier dimension. A 2D convolution layer with stride 1 (standard setting) is applied in operation 1302-B. Then in operation 1302-C, a number Nₐₙₜ of different 2D convolution layers all take the output of operation 1302-B and generate Nₐₙₜ of size N_{pf}×c₆ sequences in operation 1302-D.

In operation 1303, the CNN extracted features are concatenated (1303-A) with the original input data (which was reshaped by operation 802-A) on the antenna dimension, creating a data tensor of size (1×Nₐₙₜ)×N_{pf}×(2+c₆). Then, in operations 1303-B and 1303-C, reshaping operations identical to operations 802-B and 802-C are performed to reshape the data tensor to size

$$( 1 \times \frac{{N}_{ant}}{lk} ) \times ( {N}_{pf} \times k ) \times [ ( 2 + {c}_{6} ) \times l ] .$$

After operation 1303, the CNN-enriched data from operation 1303 is fed into a pipeline including operations identical to operations 803-806 of FIGS. 8A-8B to obtain the denoised signals.

Although FIGS. 13A-13B illustrate one example BRNN-GRU based process for CE 800, various changes may be made to FIGS. 13A-13B. For example, while shown as a series of steps, various steps in FIGS. 13A-13B could overlap, occur in parallel, occur in a different order, occur any number of times, be omitted, or replaced by other steps.

When addressing denoising tasks across multiple noise levels (i.e., SNRs), some methods may involve either training separate models for each noise level or using a single model with data generated from all noise levels. However, these approaches come with significant drawbacks. Training individual models for each noise level is resource-intensive, using substantial computational power and memory. This often leads to inefficiencies, especially when noise levels vary continuously in real-world applications. On the other hand, using a single model to handle all noise levels can result in suboptimal performance, as the model may struggle to generalize across the entire range of noise intensities, leading to degraded performance at both the lower and higher extremes of noise. To overcome these drawbacks, various embodiments of the present disclosure may provide a multitask learning (MTL) framework for mixed SNRs training.

As described herein, MTL refers to a machine learning approach where a single model is trained on multiple tasks at the same time. For example, this can be achieved by sharing parameters or representations among tasks. By learning tasks together, the model can generalize better on each individual task compared to learning the task independently. MTL provides several improvements over other machine learning approaches, such as:
1) Data Efficiency: When data for a specific task is limited, MTL can leverage data from related tasks to improve learning efficiency and model performance.
2) Regularization: Sharing representations across tasks acts as a regularizer, reducing the risk of overfitting, especially in high-dimensional space.
3) Representation Learning: MTL can lead to the learning of more robust and generalized features that are useful across different tasks.

In various embodiments of the present disclosure, MTL acts as an inductive transfer mechanism where multiple learning tasks are solved simultaneously, while exploiting commonalities and differences across tasks. MTL is particularly beneficial when tasks are related and can benefit from each other's knowledge. In the context of channel estimation, signals are often contaminated by varying levels of noise (SNRs). These signals, while sharing the same ground truth, differ in the noise levels present. This scenario naturally fits within the MTL framework, where each noise level can be treated as a distinct task. In various embodiments of the present disclosure, An MTL based CE model can share representations across different noise levels while learning specialized features unique to each noise intensity. By doing so, the MTL based CE model can learn shared representations that capture the underlying signal structure while also adapting to the specific noise characteristics of each task. This approach not only enhances the model's capacity to denoise effectively across a wide range of SNRs, but also allows the model to better exploit the relationships between different noise levels. As a result, the model can generalize more effectively to unseen noise conditions, leading to improved performance in real-world scenarios where noise levels may vary unpredictably. Moreover, MTL reduces the need for training and maintaining multiple models for different noise conditions, streamlining the deployment process and making it easier to implement robust, adaptable channel estimation in dynamic environments.

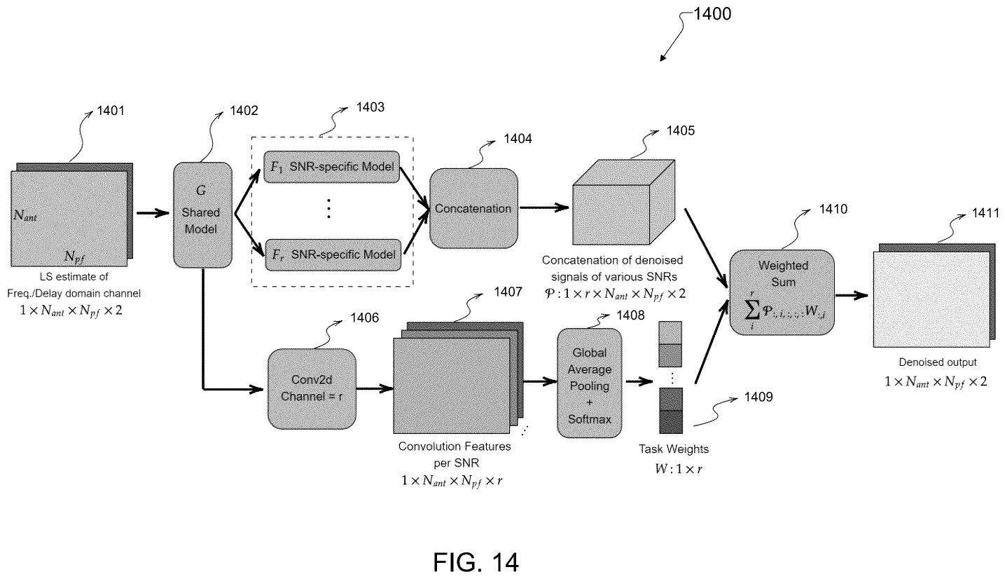

FIG. 14 illustrates an example process for MTL based mixed SNRs training 1400 according to embodiments of the present disclosure. An embodiment of the process illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for MTL based mixed SNRs training could be used without departing from the scope of this disclosure.

In the example of FIG. 14, a number r of prediction heads form r base candidates of denoised signals based on the noise level, while sharing the same embedding obtained by a shared model G. These prediction heads are much smaller compared to the shared model and therefore do not introduce significant computation overhead. Then based on the shared embedding, a mixing of weights of size r is computed using another small network. Finally, the denoised signals are a convex combination between the mixing task weights and the candidate solutions. This framework is flexible and can work with any machine learning models being applied to the channel estimation task.

In the example of FIG. 14, the training process begins in operation 1401. In operation 1401, an LS estimate

$${\hat{H}}_{p}^{LS}$$

is provided from a training data set. In the example of FIG. 14, the LS estimate

$${\hat{H}}_{p}^{LS}$$

is exemplified with size 1×Nₐₙₜ×N_{pf}×2 in the FA domain with 2 referring to the real and imaginary parts of the wireless channels. However, it should be understood that the training process of FIG. 14 is not limited to this particular size example of an LS estimate

$${\hat{H}}_{p}^{LS} .$$

In operation 1402, LS estimate

$${\hat{H}}_{p}^{LS}$$

is fed to a shared model G in to obtain the shared features.

In operation 1403, assuming that shared model G is being trained with data from r different noise levels (SNRs), the shared features are fed into r different SNR-specific models, F₁, . . . , Fᵣ and obtaining r different candidate outputs, each of size 1×Nₐₙₜ×N_{pf}×2. These candidates are then concatenated to form a candidate tensor [symbol] of size 1λr×Nₐₙₜ×N_{pf}×2, as shown in operations 804 and 805 respectively.

In operation 1406, the same shared features generated from operation 1402 are fed into a 2D convolution with output channels equal to r to obtain convolution features in operation 1407 of size 1×Nₐₙₜ×N_{pf}×r.

In operation 1408, a global average pooling layer is leveraged, and weights vectors W of size 1×r (1409) are computed by using the softmax function.

In operation 1410, a convex combination of the candidate outputs with respect to the weight vectors W is computed, obtaining the final denoised output 1411 in the form of

$${\sum }_{i}^{r} {𝒫}_{: , i , : , : , :} {W}_{: , i} .$$

Although FIG. 14 illustrates one example process for MTL based mixed SNRs training 1400, various changes may be made to FIG. 14. For example, while shown as a series of steps, various steps in FIG. 14 could overlap, occur in parallel, occur in a different order, occur any number of times, be omitted, or replaced by other steps.

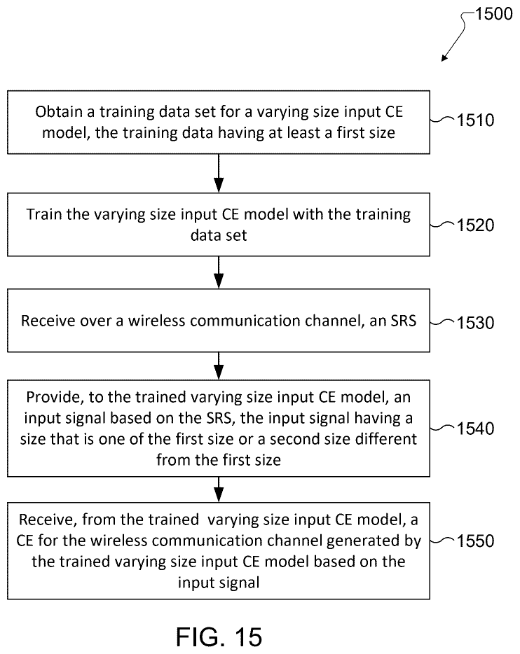

FIG. 15 illustrates an example method 1500 for NN-based CE with varying input sizes according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for NN-based CE with varying input sizes could be used without departing from the scope of this disclosure.

In the example of FIG. 15, method 1500 begins at step 1510. At step 1510 at least one element of a wireless network (hereinafter “network element”) such as BS 102 of FIG. 1 obtains a training data set for a varying size input CE model. For example, the at least one network element may comprise a cyclic prefix OFDM uplink system with a channel estimation model as shown in FIG. 5. The training data of the training data set has at least a first size. In other words, the training data of the training data set may vary in size.

At step 1520, the at least one network element trains the varying size input CE model with the training data set.

In some embodiments, to train the varying size input CE model with the training data set, the at least one network element may (i) split data from the training data set into a plurality of split data batches, (ii) transpose each split data batch of the plurality of split data batches into a split example batch, (iii) determine a gradient with regard to a loss function for each split example batch, (iv) determining an average gradient based on the gradient for each split example batch, and (v) update a gradient descent parameter of the varying size input CE model based on the average gradient, similar as shown in FIG. 12

In some embodiments, the at least one network element may train the varying size input CE model according to an MTL framework for mixed SNRs. In some embodiments, to train the varying size input CE model according to the MTL framework, the at least one network element may be configured to (i) provide an input signal to a shared model G, (ii) feed shared features from r different SNRs into r different SNR specific models to obtain r candidate outputs, (iii) concatenate the r candidate outputs to form a candidate tensor [symbol] , (iv) feeding the features from the r different SNRs into a 2D convolution with r output channels to obtain convolution features, (v) determine weight vectors W of the convolution features, (vi) determining a convex combination of the r candidate outputs with respect to the weight vectors W, and (vii) determine a denoised output based on the convex combination, similar as shown in FIG. 14.

In some embodiments, after the network is trained at step 1520, the at least one network element may test the varying size input CE model with a testing data set. To test the varying size input CE model with the testing data set, the at least one network element may (i) split data from the testing data set into split data, (ii) transpose the split data into split examples, (iii) provide the split examples to the varying size input CE model, (iv) receive split denoised signals from the CE model based on the split examples, and (v) reshape the split examples into a final denoised signal, similar as shown in FIG. 11.

At step 1530, the at least one network element receives, over a wireless communication channel, an SRS (for example, from UE 116 of FIG. 1).

At step 1540, the at least one network element provides, to the trained varying size input CE model, an input signal based on the SRS. The input signal has a size that is one of the first size or a second size different from the first size. That is to say, the input signal can be identically sized or have a different size from the size of the data used to train the varying size input CE model.

At step 1550, the at least one network element receives, from the trained varying size input CE model, a CE for the wireless communication channel generated by the trained varying size input CE model based on the input signal.

While steps 1510-1550 are described above as being performed by the same at least one network element, this is merely for ease of explanation. For example, in some embodiments, each of steps 1510-1550 may be performed by a different network element, or a different plurality of network elements.

In some embodiments, the varying size input CE model may be a BRNN-GRU CE model. In some embodiments, to generate the CE for the wireless communication channel, the BRNN-GRU CE model may be configured to (i) determine a LS estimate of the input signal, (ii) reshape the LS estimate into a reshaped LS estimate, (iii) map, according to a hidden state size, the reshaped LS estimate into GRU output; (iv) linear project the GRU output into projected GRU output; and (v) reshape the projected GRU output to a denoised output, wherein the denoised output is the CE, similar as shown in FIGS. 8A-8B.

In some embodiments, the varying size input CE model may be a ResNet CE model. In some embodiments, to generate the CE for the wireless communication channel, the ResNet CE model may be configured to (i) determine a LS estimate of the input signal, (ii) project the LS estimate to a channel size c output, (iii) perform a ResNet block operation on the channel size c output to generate ResNet block output; and (iv) project the ResNet block output to a denoised output, wherein the denoised output is the CE, similar as shown in FIG. 9.

In some embodiments, the varying size input CE model may be a U-Net CE model. In some embodiments, to generate the CE for the wireless communication channel, the U-Net CE model may be configured to (i) determine a LS estimate of the input signal, (ii) project the LS estimate to a channel size c output, (iii) perform a U-Net module operation on the channel size c output to generate U-Net module output; and (iv) project the U-Net module output to a denoised output, wherein the denoised output is the CE, similar as shown in FIG. 10.

In some embodiments, the varying size input CE model may be a CNN feature powered RNN CE model. In some embodiments, to generate the CE for the wireless communication channel, the CNN feature powered RNN CE model may be configured to (i) determine a LS estimate of the input signal, (ii) perform a downsampling operation to LS estimate to generate downsampled data, (iii) concatenate and reshape the downsampled data into a reshaped LS estimate, (iv) map, according to a hidden state size, the reshaped LS estimate into GRU output, (v) linear project the GRU output into projected GRU output, and (vi) reshape the projected GRU output to a denoised output, wherein the denoised output is the CE, similar as shown in FIGS. 13A-13B.

Although FIG. 15 illustrates one example method 1500 for NN-based CE with varying input sizes, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a processor configured to:
obtain a training data set for a varying size input channel estimation (CE) model, the training data having at least a first size; and
train the varying size input CE model with the training data set; and
a transceiver operatively coupled to the processor, the transceiver configured to receive, over a wireless communication channel, a sounding reference signal (SRS),
wherein the processor is further configured to:
provide, to the trained varying size input CE model, an input signal based on the SRS, the input signal having a size that is one of the first size or a second size different from the first size; and
receive, from the trained varying size input CE model, a CE for the wireless communication channel generated by the trained varying size input CE model based on the input signal.

2. The BS of claim 1, wherein the processor is further configured to:
split data from a testing data set into split data;
transpose the split data into split examples;
provide the split examples to the varying size input CE model;
receive split denoised signals from the CE model based on the split examples; and
reshape the split examples into a final denoised signal.

3. The BS of claim 1, wherein to train the varying size input CE model with the training data set, the processor is further configured to:
split data from the training data set into a plurality of split data batches;
transpose each split data batch of the plurality of split data batches into a split example batch;
determine a gradient with regard to a loss function for each split example batch;
determine an average gradient based on the gradient for each split example batch; and
update a gradient descent parameter of the varying size input CE model based on the average gradient.

4. The BS of claim 1, wherein:
the varying size input CE model is a bidirectional recurrent neural networks-gated recurrent unit (BRNN-GRU) CE model; and
to generate the CE for the wireless communication channel, the BRNN-GRU CE model is configured to:
determine a least squares (LS) estimate of the input signal;
reshape the LS estimate into a reshaped LS estimate;
map, according to a hidden state size, the reshaped LS estimate into gated recurrent unit (GRU) output;
linear project the GRU output into projected GRU output; and
reshape the projected GRU output to a denoised output, wherein the denoised output is the CE.

5. The BS of claim 1, wherein:
the varying size input CE model is a residual neural networks (ResNet) CE model; and
to generate the CE for the wireless communication channel, the ResNet CE model is configured to:
determine a least squares (LS) estimate of the input signal;
project the LS estimate to a channel size c output;
perform a ResNet block operation on the channel size c output to generate ResNet block output; and
project the ResNet block output to a denoised output, wherein the denoised output is the CE.

6. The BS of claim 1, wherein:
the varying size input CE model is a U-network (U-Net) CE model; and
to generate the CE for the wireless communication channel, the U-Net CE model is configured to:
determine a least squares (LS) estimate of the input signal;
project the LS estimate to a channel size c output;
perform a U-Net module operation on the channel size c output to generate U-Net module output; and
project the U-Net module output to a denoised output, wherein the denoised output is the CE.

7. The BS of claim 1, wherein:
the varying size input CE model is a convolutional neural networks (CNN) feature powered recurrent neural networks (RNN) CE model; and
to generate the CE for the wireless communication channel, the CNN feature powered RNN CE model is configured to:
determine a least squares (LS) estimate of the input signal;
perform a downsampling operation to LS estimate to generate downsampled data;
concatenate and reshape the downsampled data into a reshaped LS estimate;
map, according to a hidden state size, the reshaped LS estimate into gated recurrent unit (GRU) output;
linear project the GRU output into projected GRU output; and
reshape the projected GRU output to a denoised output, wherein the denoised output is the CE.

8. The BS of claim 1, wherein the processor is further configured to train the varying size input CE model according to a multitask learning (MTL) framework for mixed signal-to-noise ratios (SNRs).

9. The BS of claim 8, wherein to train the varying size input CE model according to the MTL framework, the processor is further configured to:
provide an input signal to a shared model G;
feed shared features from r different SNRs into r different SNR specific models to obtain r candidate outputs;
concatenate the r candidate outputs to form a candidate tensor P;
feed the features from the r different SNRs into a 2D convolution with r output channels to obtain convolution features;
determine weight vectors W of the convolution features;
determine a convex combination of the r candidate outputs with respect to the weight vectors W; and
determine a denoised output based on the convex combination.

10. A method of operating a base station (BS), the method comprising:
obtaining a training data set for a varying size input channel estimation (CE) model, the training data having at least a first size;
training the varying size input CE model with the training data set;
receiving, over a wireless communication channel, a sounding reference signal (SRS);
providing, to the trained varying size input CE model, an input signal based on the SRS, the input signal having a size that is one of the first size or a second size different from the first size; and
receiving, from the trained varying size input CE model, a CE for the wireless communication channel generated by the trained varying size input CE model based on the input signal.

11. The method of claim 10, wherein the method further comprises:
splitting data from a testing data set into split data;
transposing the split data into split examples;
providing the split examples to the varying size input CE model;
receiving split denoised signals from the CE model based on the split examples; and
reshaping the split examples into a final denoised signal.

12. The method of claim 10, wherein to train the varying size input CE model with the training data set, the method further comprises:
splitting data from the training data set into a plurality of split data batches;
transposing each split data batch of the plurality of split data batches into a split example batch;
determining a gradient with regard to a loss function for each split example batch;
determining an average gradient based on the gradient for each split example batch; and
updating a gradient descent parameter of the varying size input CE model based on the average gradient.

13. The method of claim 10, wherein:
the varying size input CE model is a bidirectional recurrent neural networks-gated recurrent unit (BRNN-GRU) CE model; and
to generate the CE for the wireless communication channel, the BRNN-GRU CE model is configured to:
determine a least squares (LS) estimate of the input signal;
reshape the LS estimate into a reshaped LS estimate;
map, according to a hidden state size, the reshaped LS estimate into gated recurrent unit (GRU) output;
linear project the GRU output into projected GRU output; and
reshape the projected GRU output to a denoised output, wherein the denoised output is the CE.

14. The method of claim 10, wherein:
the varying size input CE model is a residual neural networks (ResNet) CE model; and
to generate the CE for the wireless communication channel, the ResNet CE model is configured to:
determine a least squares (LS) estimate of the input signal;
project the LS estimate to a channel size c output;
perform a ResNet block operation on the channel size c output to generate ResNet block output; and
project the ResNet block output to a denoised output, wherein the denoised output is the CE.

15. The method of claim 10, wherein:
the varying size input CE model is a U-network (U-Net) CE model; and
to generate the CE for the wireless communication channel, the U-Net CE model is configured to:
determine a least squares (LS) estimate of the input signal;
project the LS estimate to a channel size c output;
perform a U-Net module operation on the channel size c output to generate U-Net module output; and
project the U-Net module output to a denoised output, wherein the denoised output is the CE.

16. The method of claim 10, wherein:
the varying size input CE model is a convolutional neural networks (CNN) feature powered recurrent neural networks (RNN) CE model; and
to generate the CE for the wireless communication channel, the CNN feature powered RNN CE model is configured to:
determine a least squares (LS) estimate of the input signal;
perform a downsampling operation to LS estimate to generate downsampled data;
concatenate and reshape the downsampled data into a reshaped LS estimate;
map, according to a hidden state size, the reshaped LS estimate into gated recurrent unit (GRU) output;
linear project the GRU output into projected GRU output; and
reshape the projected GRU output to a denoised output, wherein the denoised output is the CE.

17. The method of claim 10, wherein the varying size input CE model is trained according to a multitask learning (MTL) framework for mixed signal-to-noise ratios (SNRs).

18. The method of claim 17, wherein to train the varying size input CE model according to the MTL framework, the method further comprises:
providing an input signal to a shared model G;
feeding shared features from r different SNRs into r different SNR specific models to obtain r candidate outputs;
concatenating the r candidate outputs to form a candidate tensor P;
feeding the features from the r different SNRs into a 2D convolution with r output channels to obtain convolution features;
determining weight vectors W of the convolution features;
determining a convex combination of the r candidate outputs with respect to the weight vectors W; and
determining a denoised output based on the convex combination.

19. A non-transitory computer readable medium embodying a computer program comprising program code that, when executed by a processor of a device, causes the device to:
obtain a training data set for a varying size input channel estimation (CE) model, the training data having at least a first size; and
train the varying size input CE model with the training data set;
receive, over a wireless communication channel, a sounding reference signal (SRS), provide, to the trained varying size input CE model, an input signal based on the SRS, the input signal having a size that is one of the first size or a second size different from the first size; and
receive, from the trained varying size input CE model, a CE for the wireless communication channel generated by the trained varying size input CE model based on the input signal.

20. The non-transitory computer readable medium of claim 19, wherein to train the varying size input CE model with the training data set, the program code, when executed by the processor of the device, causes the device to:
split data from the training data set into a plurality of split data batches;
transpose each split data batch of the plurality of split data batches into a split example batch;
determine a gradient with regard to a loss function for each split example batch;
determine an average gradient based on the gradient for each split example batch; and
update a gradient descent parameter of the varying size input CE model based on the average gradient.
